(19) United States
(12) Patent Application Publication
(10) Pub. No.: US 2006/0024564 A1
(43) Pub. Date: Feb. 2, 2006

(54) Manclaw-Harrison fuel cell

(76) Inventors: Ronald R. Manclaw, Pompano Beach, FL (US); Nicholas D. Harrison, Norfolk, VA (US)

Correspondence Address: Nicholas D. Harrison, 2915 Creekwood Road, Norfolk, VA, 23518-2308, US

(21) Appl. No.: 10/886,275

(22) Filed: Jul. 6, 2004

(51) Int. Cl. H01M 8/08; H01M 4/90

(52) U.S. Cl. 429/46; 429/40

(57) ABSTRACT

The Manclaw-Harrison Fuel Cell is a new Environmentally SAFE Fuel Cell (Lead Free, Acid Free, Mercury Free and has No Heavy Metals), and as such, it sets the definition of a new Class of Fuel Cell device because it has been verified to be a Non-Faraday device, making it the first such device discovered in the past 160+ years. See the “Preamble” for a more technical explanation.

### FIELD OF THE INVENTION

This invention relates generally to the art of Fuel Cell manufacturing, and processes, and more specifically to an improved Electrolyte for enhancing oxidation-reduction reactions in Fuel Cells and other Power Storage and Generating devices, such as batteries and disposable “one-time use” Fuel Cells. Furthermore, this invention offers promise for reducing the negative environmental impact, world-wide, of all currently existing disposable “one-time use” Fuel Cells or devices by specific design to address all of the problems involved with recyclability in that all component elements in this invention are able to be recycled without toxic waste or by-products.

### BACKGROUND OF THE INVENTION

All previous Michael Faraday's Law related devices, batteries, storage devices, and fuel cells are electrochemical devices that convert chemical potential energy into usable direct current electricity and heat without combustion as an intermediate step. Generally such devices feature two electrodes, an anode and cathode, separated by a porous membrane in an electrolyte, as in (P.E.M.) “Proton Exchange Membrane” devices. Like batteries, fuel cells are combined into groups, called stacks, or sets of stacks or fuel cells in order to obtain a usable voltage and power output.

Past and present fuel cell art converts the energy typically in a hydrogen-rich fuel directly into electricity and operates as long the elements in the device are supplied with fuel and oxidant as is commonly known as (SoFC) Solid Oxide/Oxygen Fuel Cells.

Although Fuel cells produce historically almost no sulfur and nitrogen compounds from conventional combustion of coal-derived gas, natural gas, methane (from corn or other bio-fuels), gasoline, diesel fuel, alcohols (Ethanol), and other fuels containing hydrocarbon and sulfur compounds: including alcohols, gasoline, or diesel fuel, many of these devices including (SoFC) Solid Oxide/Oxygen Fuel Cells produce significant wastes and heat to the environment affecting global warming. The Manclaw-Harrison Fuel Cell does not require the addition of heat into the device in order reach an operating temperature or to produce power.

Generally such fuel cell devices known in this field are used for Primary and/or Secondary backup power, but in the case of “one-time use” fuel cell devices, once activated, the device will run un-interruped until its components fail and/or fuel are exhausted. Once the need for the backup or emergency power is satisfied, the remaining power, and material of such devices are wasted and disposed of in public refuse collection facilities or even discarded with abandon to the environment, resulting toxic waste, contamination of water tables and resources, and loss of wild-life. Human society, with ever increasing population, is demanding non-toxic, recyclable, and environmentally safe solutions.

### SUMMARY OF THE INVENTION

According to principles of this invention, each Fuel Cell consists of a pair or series of Cathode and Anode Metal (and/or Metal-composite) Plates, immersed in an environmentally safe, non-acidic (Peroxide Based) Electrolyte. Currently, similar existing Fuel Cell technologies employ an Anode which is heated or oxidized in the presence of “air” to produce power/voltage/current.

The Fuel Cell described in the embodiment of this application differs from all previously known Faraday devices. Each Fuel Cell described herein is arranged as a stack of (or set of “Staged on Demand”) Fuel Cell(s), consisting of parallel Cathode and Anode plates separated by a porous membrane or divider which allows the electrolyte to carry electrons and ions between said plates as the chemical reaction(s) take place producing a current flow and corresponding by-products of a chemical oxidation-reduction reaction incorporating a unique and new class of electrolyte which does not consume the Cathode material during the oxidation-reduction reaction process; and as such, this invention is unique in establishing this device in its own Class/Sub-class of Patent devices as different from past known “P.E.M.” voltaic, galvanic, and electrolytic cells; and as such, establishes a new class of Aluminum (or other) Oxide Fuel Cell.

### REFERENCE TO AND BRIEF DESCRIPTION OF THE DRAWINGS

FIG. 1—Manclaw-Harrison Simple Primary Fuel Cell

FIG. 1.A—Honeycomb Anode Geometry

FIG. 2—Manclaw-Harrison Primary Fuel Cell with a Plurality of Cathode/Electrodes
See: Plastic Insulator Ring (or other non-conductive material)

FIG. 2.A—Honeycomb Anode

FIG. 3—(Cross-sectional view) is a linear cell design, or may represent one cross-section of a Honeycomb (staged) Fuel Cell, or array of Fuel Cells.

FIG. 4—“Double-Cathode” Fuel Cell Sub Unit or Single Fuel Cell component
See: ANODE (Aluminum Plate) (−) (+) CATHODE (Copper Plate)

FIG. 4.A—“Double-Cathode” Laboratory demonstration Apparatus of (FIG. 4)
Acrylic container (---)
See: (Al) Metallized Aluminum (Anode)
See: (Cu) Metallized Copper Cup (Cathode)
See: Fiberglass Separator

FIG. 5—Manclaw-Harrison “Peltier Effect device Heated or Chilled Can/Container with Integrated Fuel Cell”

FIG. 5.A—(Plastic Insulator)

Note: All (underlined) text above has been moved (or replicated), from the original drawings, to this section. No new matter has been introduced.

### DETAILED DESCRIPTION OF THE INVENTION

A Military, Aerospace and/or Emergency/Rescue version of this Fuel Cell with a Kevlar or other Polymer based encasement for “bullet-proof” or battle-hardened conditions is the first to claim that even when damaged by a bullet or shrapnel, the contents of the electrolyte will not be injurious to normal human skin. (Exposure of an “open wound” however needs to be tested, before further claim(s) or warnings may be added.)

Preamble:

The Manclaw-Harrison Fuel Cell is comprised of a Fuel Cell, or (stack, or set of) Fuel Cell(s), of the type “Aluminum (or other) Oxide,” consisting of a pair of Metal Plates, or Metal-Composite Plates, immersed in an environmentally safe, non-acidic (Electrolyte) solution which produces electron flow and therefore current flow from Anode to Cathode, when connected via wire(s) or other such conductor(s) through any electrical load. Of further note, is the observation that the Cathode in this unique invention does not get “used up” in the reaction as this Fuel Cell produces electrical current, and as such, differs from “Proton Exchange Membrane” (P.E.M.) devices defined by the standard definition of Faraday's Law(s) dealing with voltaic/galvanic and electrolytic cells.

All existing batteries, and Fuel Cells, including similar electrolytic cells known at present, obey Faraday's Law(s) which states that “during electrolysis the passage of 1 Faraday through the circuit brings about the oxidation of one equivalent weight of a substance at one electrode (Anode) and reduction of one equivalent weight of a substance at the other electrode (cathode).” Note that in all cells, oxidation occurs at the Anode and reduction occurs at the Cathode.”—Ref.: “Essentials of Chemistry” by Dr. M. Fogiel, Dir. Of Research and Education Association, 61 Ethel Road West Piscataway, N.J. 08854. See also: (ISBN: 0-87891-580-X) Library of Congress Number: 00-134282 published by Research and Education Association (www.rea.com).

As a result of our “new” Fundamental Scientific Discovery, the prior Faraday Law(s) of Electrochemistry will need to be revised as follows:

All existing batteries, and Fuel Cells, including similar electrolytic cells known at present, obey the “new” Manclaw-Harrison Law(s) which states that “during electrolysis the passage of 1 Faraday through the circuit brings about the oxidation of one equivalent weight of a substance at one electrode (Anode) and reduction of one equivalent weight of a substance at the other electrode (cathode) or one equivalent weight of a substance dissolved in the Electrolytic Solution.” Note that in all cells, oxidation occurs at the Anode and reduction occurs at the Cathode or in the Electrolytic Solution.”—by Nicholas D. Harrison, Scientist & Principal Engineer; and Ronald R. Manclaw, Principal Engineer.

Footnotes: Definition of Terms (Used Herein)

Note, in Voltaic/Galvanic cells, the Anode₂ is negative and the Cathode, is positive, as in said “Fuel Cell” described in the embodiment of this invention.
(1) Cathode—in this patent the term “Cathode” refers to the Copper (Cu) or other such Metal or Composite₄ Electrode or Plate which carries current away from the Fuel Cell, or Fuel Cell Sub-Unit [or Sub Cell or Single Cell], as it is the “positive” charge carrying plate, which receives electron flow from the load attached to the exterior of the Fuel Cell, or Fuel Cell Sub-Unit [or Sub Cell or Single Cell].
(2) Anode—in this patent the term “Anode” refers to the Aluminum (Al) or other such Metal or Composite₄ Electrode or Plate which carries current toward the Fuel Cell, or Fuel Cell Sub-Unit [or Sub Cell or Single Cell], as it is the “negative” charge carrying plate, which emits electron flow to the load attached to the exterior of the Fuel Cell, or Fuel Cell Sub-Unit [or Sub Cell or Single Cell].
(3) “Staged Activation” or “Staged on Demand” or “Staged Activation on Demand”—refers to the activation, in stages, of Fuel Cell components, and/or sub-components (in part or as a whole) in that said components and/or sub-components are activated in whatever order as “time sequenced” or successive events as the application or user's demand (resistive/inductive/capacitive or other such load) draws power from said Fuel Cell device.
(4) Metal-composite—Powderized Metal or Metallized powder mixed with other binding agents to form a sheet or layered electrically conductive plate, or surface, or other similar device.

End of FOOTNOTE(s),

(typographical and logical changes to be continued after Patent Attorney review).

### Description of a “Device” Application of the Invention

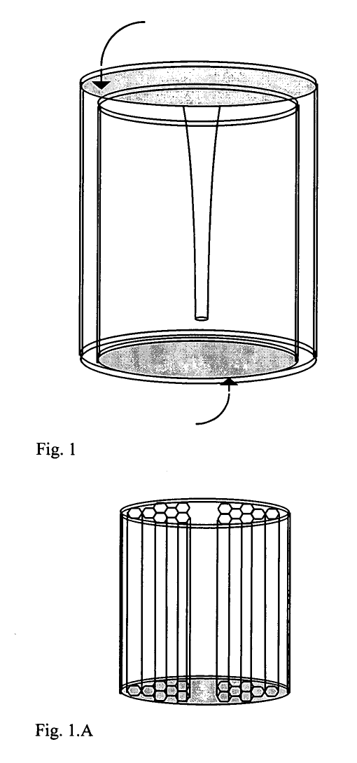

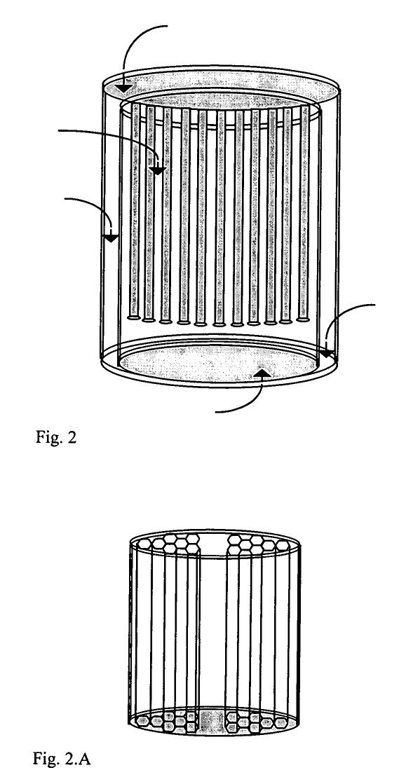

FIG. 1 Manclaw-Harrison Simple Primary Fuel Cell
(+) Single CATHODE (Copper/Cathode Cup)
Shaded Area is the Cathode Metal Point of Contact.

The top of the Anode Cup may employ a thin polymer seal, to keep the Electrolyte from leaking, which is pierced by the cathode rod(s), when the Fuel Cell is activated.

Electrolyte

FIG. 1.A is a Honeycomb Anode
Plastic Insulator Ring—separates anode from cathode providing safe encapsulation.
   Single (−) ANODE (Shaded Area is the Anode Metal Point of Contact).
      (Aluminum, or Aluminum-Magnesium (Al—Mg or other composite) Metallized Honeycomb Matrix)

The Manclaw-Harrison (Unique Honeycomb design) Primary Fuel Cell, FIG. 1, above, is one of several primary or basic reusable fuel cells designed by Nicholas D. Harrison and R. M. Manclaw.

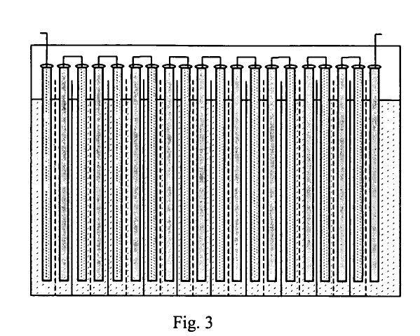

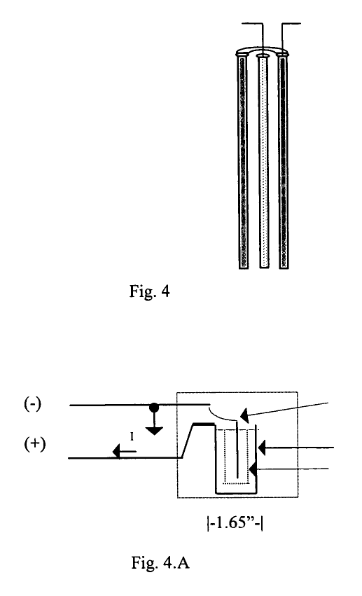

FIG. 1.A. is the embodiment of the second primary Basic Reusable NON-FARADAY (Metal-Oxide) FUEL CELL, as it would be incorporated into FIG. 1 (above), see FIG. 2 (next page); and FIG. 3 (following page after next) which is the embodiment of the third style of Basic Reusable NON-FARADAY (Metal-Oxide) FUEL CELL. The Center Cathode Rod or Rods (in the case of FIG. 2—next page) are inserted, via a compression or twisting (screw-in or other) motion or actuation/control into the space between the Anode walls, containing the Electrolyte, thus activating the Fuel Cell for operation.

Likewise in alternate embodiments, the Anode Honeycomb component is inserted, via a compression or twisting (screw-in or other) motion or actuation/control into the space between the Cathode Rod or Rods, or Metallized subcells or Honeycomb cells designed to fit/conform with the Anode Honeycomb containing the Electrolyte, thus activating the Fuel Cell for operation.

This design allows the development of Multi-Staged Fuel Cells comprised of groups of cells utilizing the unique Honeycomb Matrix design, described herein, which allows activation of individual stages “on demand.”

FIG. 2 Manclaw-Harrison Primary Fuel Cell with a Plurality of Cathode/Electrodes (below):
(+) CATHODE (Copper/Graphite/Carbon Cathode Cup)
Shaded Area is the Cathode Metal Point of Contact.
   Electrolyte

FIG. 2.A Honeycomb Anode (above)
Plastic Insulator Ring—separates anode from cathode; providing safe encapsulation.
(−) ANODE Shaded Area is the Anode Metal Point of Contact.
   (Aluminum, or Aluminum-Magnesium (Al—Mg or other composite) Metallized Honeycomb Matrix)
   The Manclaw-Harrison Primary Fuel Cell, FIG. 2, is the primary basic reusable Fuel Cell designed by Nicholas D. Harrison and R. M. Manclaw, said Fuel Cell may be configured in simple or complex Unique Honeycomb arrangements allowing “staged activation” of the Fuel Cell.
   The Electrolyte is prepared using the following mixing procedure and results in a unique, non-toxic, non-acidic and Environmentally safe Electrolyte, which even if discarded breaks down into components common to the ocean environment.

Typical Electrolyte Mixing Procedure:
Mix [Sodium Percarbonate Na₄H₈C₂O₁₂+Sodium carbonate Na₂CO₃]+[“Morton Salt”: NaCl]+[3% Peroxide Solution: H₂O₂+H₂O]+Al (Anode)+Cu inside the Cathode Cup)→which produces the following products:
Aluminum Chloride or Oxide+e−(electrons)+(White, cool, ignitable Gas: H₂ or O₂?).

Note that the (Cu) Copper based CATHODE (Copper/Graphite/Carbon Cathode Cup) remains unaffected, and “not oxidized,” even after repeated uses, and complete discharge cycles. Na₄H₈C₂O₁₂+Na₂CO₃+3% H₂O₂+H₂O+NaCl+Al⁺Cu=Al₂O₃ or AlCl₃+Cu+(White cool Gas).

The end products may contain water, oxygen, and soda ash: [Na₂CO₃].

FIG. 3 Manclaw-Harrison Rectangular Simple Industrial or Marine Primary Fuel Cell (below):

The Manclaw-Harrison Rectangular Simple Industrial or Marine Primary Fuel Cell is a “rectangular” battery-like configuration, like a Lantern Battery, or Auto/Marine/Lawn & Recreational style of battery packaging configuration consisting of parallel Cathode and Anode plates—separated by a porous membrane or divider which allows the electrolyte to carry electrons and ions between said plates as the chemical reaction(s) take place producing a current flow and corresponding by-products of the chemical oxidation-reduction reaction. This Fuel Cell may be integrated into applications requiring redundant backup (stand-by) power auxiliary, “on-demand” or “automatic” enhanced power output, or supplemental power during periods of high demand, or EMERGENCY use, or as primary or secondary backup power during outage periods. Said Fuel Cell(s) may be activated or re-activated by automatic or electronic means for “on-demand” applications.
ANODE (Aluminum Plate) (−)
CATHODE (Copper Plate) (+)
Fuel Cell Container—
   Electrolyte

(-------) Dark Shaded plates are the Cathode Metal, separated by a porous membrane or divider, which has no other function than to separate the Anode and Cathode plates to prevent them from having an electrical short circuit; these plates are shown as a dashed line (----) from the Lighter Shaded plates that are Anode Metal.

The solid vertical lines are non-porous dividers that separate each Plate pair.

Each Anode and Cathode Plate pair—make up one Fuel Cell sub-unit or Sub Cell or Single Cell. (Cross-sectional view) FIG. 3 is a linear cell design, or may represent one cross-section of a Honeycomb (staged) Fuel Cell, or array of Fuel Cells.

The Fuel Cell depicted in FIG. 3 (above) consists of 10 pairs of alternating Aluminum and Copper plates, arranged in series and connected via stainless steel straps riveted or bonded to each plate; each plate pair are connected to the next in the series to allow current flow from Anode to Cathode, or electron flow from Cathode to Anode. At each end of the entire Fuel Cell arrangement is an Anode and a Cathode Plate respectively connected to the outside world, or load, via a final stainless steel (or other metal) strap or other electrical connecting device.

The Fuel Cell, depicted in FIG. 3, represents the embodiment of a “recyclable” Multi-Staged “on demand” Fuel Cell for Automotive, Industrial, Marine, Recreational, Military, EMERGENCY (Vehicle/Backup/COMSEC/) et. Al. Applications requiring EMERGENCY Re-cyclable backup power which is environmentally Non-Toxic and SAFE to handle and store for long durations.

Lab Tests:

Actual lab tests run on a single Fuel Cell Sub-Unit of the above fuel cell produced 0.15 volts DC at a current of 1.0 A to a peak of 1.50 Amperes continuously for a minimum of 4 hours. The Current curve is very flat and stable for the 4 hour duration. The same tests were repeated several times with exactly the same results from each test. A ten plate pair Fuel Cell, as above, will deliver at a minimum 1.5 volts, at 1.0 to 1.50 Amperes continuously for a minimum of 4 hours. That's a total of 1.50 Watts (minimum), to 2.25 Watts continuously for a minimum of 4 hours. The net total rating is then 6.0 to 9.0 Watt-Hours.

It is expected that minor changes in the Electrolyte chemistry and the anode chemistry will increase the voltage per plate pair from 0.15 volts to well over 1.0 volts to an expected maximum of about 2.75 to 3 volts. The WH rating of course will correspondingly improve as will the current output. Aluminum Anodes, which were ¼ inch in thickness and 4 inches by 4 inches in area, of the Type known in the metal industrial codes as #3003 were used in prototype testing.

FIG. 4 “Double-Cathode” Fuel Cell Sub Unit or Single Fuel Cell component

Another embodiment of a Fuel Cell Sub-Unit—Sub Cell or Single Cell is the following “Double-Cathode” with a single Anode in the “center of the sandwich.” This arrangement can provide improved current production or output, and power output respectively.
ANODE (Aluminum Plate) (−)
CATHODE (Copper Plate) (+)

FIG. 4 “Double-Cathode” Fuel Cell Sub Unit or Single Fuel Cell component (above)
Laboratory demonstration Apparatus of the above FIG. 4 Acrylic container (---)
   (−) Al, or other Metal (Anode)
   (+)¹ Cu (Cathode)
Fiberglass Separator
   |-1.65″-|

FIG. 4.A Laboratory demonstration Apparatus of the above (FIG. 4) Acrylic container (---)

#259 Copper Plate (0.025×4×10 inches) folded into a cup 4″ in height on each side, with a horizontal Flap on the left protruding outward so as to be available as the (+) Cathode; and a wire or stainless steel (or other metal) strap or connecting device connected to the Aluminum (Al) or other metal as the (−) Anode.

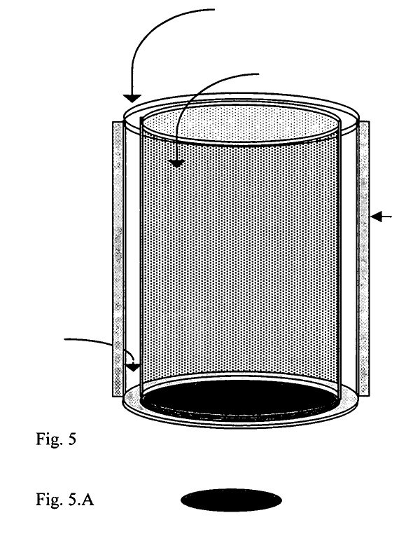

FIG. 5 Manclaw-Harrison “Peltier Effect Heated/Chilled Can/Container with Integrated Fuel Cell” Wednesday, Mar. 10, 2004

The integrated Fuel Cell is used to drive an Integrated Thin Film Peltier Effect Cooling/Heating Device.

The outermost layer of the device is coated with a Thermal insulator to conserve heat/cold and to protect the user from thermal effects.
(+) CATHODE (Copper/Graphite/Carbon Cathode Cup)
Exterior Cathode Conductive Carbon Polymer and/or
Metal Point of Contact.
Integrated Thin Film Peltier Effect Cooling Device,
attached to the interior of the Anode Cup,
heats/chills the interior (shaded region).
   Thermal insulator—to conserve heat/cold.
   Electrolyte
   (Plastic Insulator)
Interior (−) ANODE
(Aluminum/Magnesium (Al/Mg) Metal Matrix)
(Darker Shaded Area is a Plastic Insulator Separating the Anode from the Cathode.

The Manclaw-Harrison “Heated/Chilled Can or Container with Integrated Fuel Cell” designed by Nicholas D. Harrison, and Ronald R. Manclaw has a unique Integrated Thin Film Peltier Effect Cooling/Heating Device which chills (or warms) the interior soda or other (food, medical, et. Al.) container can when activated.

The Electrolyte Gel will consist of the Electrolyte mixture, described herein, with a Gel additive which also helps to stabilize the electrolyte until activated.

Note that the (Cu) Copper based CATHODE (Copper/Graphite/Carbon Cathode Cup) remains unaffected, and “not oxidized or reduced,” even after repeated uses, and partial or full complete discharge cycles. The end products may contain water, oxygen, and soda ash: [Na₂CO₃].

The embodiments of the invention in which an exclusive property or privilege are claimed are defined as follows:

1. A Fuel Cell, or (stack, or set of, or set of “Staged on Demand”) Fuel Cell(s), consisting of parallel Cathode₁ and Anode₂ plates separated by a porous membrane or divider which allows the electrolyte to carry electrons and ions between said plates as the chemical reaction(s) take place producing a current flow and corresponding by-products of a chemical oxidation-reduction reaction incorporating a unique and new class of electrolyte which does not consume the Cathode₁ material during the oxidation-reduction reaction process; and as such, this claim is unique in establishing this device in its own Class/Sub-class of Patent devices as different from past known “P.E.M.” voltaic, galvanic, and electrolytic cells; and as such, establishes a new class of Aluminum (or other) Oxide Fuel Cell.

2. A Fuel Cell, or (stack, or set of, or set of “Staged on Demand”) Fuel Cell(s), of the type “Aluminum, Magnesium (or other) Oxide,” consisting of a pair or series of Cathode₁ and Anode₂ Metal (and/or Metal-composite₄, and/or Metallized-Ceramic) Plates, immersed in an environmentally safe, non-acidic (Peroxide Based) Electrolyte, which produces electron flow from Anode₂ to Cathode₁, and therefore current flow from Cathode₁ to Anode₂, when connected via wire(s) or other such conductor(s) through any electrical load.

3. A renewable Fuel Cell featuring Anode₂ and Cathode₁ elements enhanced by Chemical Vapor Deposition (CVD), Ion Implantation or other similar advanced THIN-FILM chemical doping technologies to enhance form and function of the device to meet design criteria when combined with the oxidation process featured in the Electrolyte described in the embodiment of this invention.

4. A renewable (rechargeable, recyclable and replaceable—in part or as a whole) Fuel Cell in that sub-components, such as the Cathode₁, Anode₂, and/or Electrolyte and its chemical components may be replaced (in part or as a whole) sub-component, resulting in a fully recharged Fuel Cell. Said Fuel Cell and its components/sub-components are renewable “multi-use” and/or “one-time” use devices.

5. A Cathode, in this invention does not get “used up” (or depleted) in the reaction, unlike all previously known Faraday Voltaic/Galvanic devices, as this Fuel Cell produces electrical current. As such, said Fuel Cell differs from the standard definition set forth in Faraday's Law(s) dealing with voltaic/galvanic and electrolytic cells. Only the Anode₂ and the Electrolyte get “used up” or take part in the chemical reaction process; the “electrode” referred to as the “Cathode₁” is only a current carrier to the load, outside said “Fuel Cell,” and as such, may additionally act as a catalytic “site or location,” upon which the chemical reaction, or part of the chemical reaction, involving the other reactants takes place.

6. A “[Sheet Metal or THICK or THIN FILM, molded, extruded] Copper (Cu) Molded Cathode₁ [Cu, and/or (Cu)-(Metal Powder, and/or Metallized-Ceramic) and/or (Conductive “Metallized”-Polymer)-Composite₄ or “Cu-Composite₄”] component which is incorporated into the Fuel Cell as the Cathode₁, even though it is non-reactive and therefore exists only as a catalyst and/or a current carrier, as a singular center rod or a “plurality” of center rods or cathodes, (in series and/or parallel).

7. A Fuel Cell in which unique packaging configurations in a AAA/AA/D-Cell or other style of packaging such as a “rectangular” battery configuration like a Lantern Battery, or Auto/Marine/Lawn & Recreational style of battery packaging configuration, utilizing a “plurality” of center rods or Cathodes, (in series and/or parallel) and an Anode₂ component (or plurality of Anodes) [Carbon, Carbon-Composite₄, Carbon-Al-Composite₄, Al-Composite₄], (in series and/or parallel) with a “plurality of hexagonal cells or cylinders,” for higher current and power output.

8. A [Sheet Metal or THICK or THIN FILM, Molded, Extruded] Copper (Cu) Molded Cathode₁ [Cu, Carbon, (Carbon) and/or (Cu)-(Metal Powder) and/or (Conductive “Metallized”-Polymer)-Composite₄, Cu-Composite₄] Fuel Cell with a Cathode₁ component consisting of a “plurality” of center rods or cathodes, (in series and/or parallel) is a unique and distinct design improvement for higher current and power output.

9. A [Sheet Metal or THICK or THIN FILM, Molded, Extruded] Aluminum, Magnesium or other Metallic Anode₂ [Carbon, f Carbon-Composite₄, Carbon-Al-Composite₄, Al-Composite₄] component with a “plurality of hexagonal cells or cylinders,” is a unique and distinct design improvement, over prior “battery” and “fuel cell” art, for higher current and power output, allowing for delayed or “staged activations” of said Fuel Cell(s) “on demand₃” as needed by the user or application.

10. A [THICK or THIN FILM, or molded, or extruded, or HYBRID] Fuel Cell (or stack, or set of, or set of “Staged on Demand”) Fuel Cell(s) arrangement layered or connected in parallel or series or other combination with another Fuel Cell (or stack, or set of, or set of “Staged on Demand”) Fuel Cell(s) or used in combination with other Power Storage devices (including “multi-use” and/or “one-time” use devices) in combination with other electronic devices (including but not limited to Peltier Effect devices, Heating and/or Cooling Devices, et. Al.) to meet specific needs of the user or application.

11. A Kevlar or other Polymer based encasement requires no steel or metal jacket/casing, and as such, metal is not needed in the design of said “Fuel Cell.” If the encasement is punctured or ruptured, the electrolyte, which is Non-Acidic, will not damage human skin, and as such is SAFE to handle also referred to in industry as “Human SAFE.”

12. A Kevlar or other Polymer based encasement which makes said Fuel Cell weigh less than competing designs requiring metallic encasements/encapsulation.

13. A Kevlar or other Polymer based “bullet-proof” encasement, for Military, Aerospace or Emergency/Rescue or battle-hardened conditioned version of this Fuel Cell, is the first to claim that even when damaged by a bullet or shrapnel, the contents of the electrolyte will not be injurious to normal human skin. (Exposure of an “open wound” however needs to be tested, before further claim(s) or warnings may be added.)

14. A premixed or Binary (2 part) Electrolyte is inserted into the Cathode1 component and/or the Anode₂ component during assembly, and the Electrolyte and Fuel Cell remains “inactive,” having virtually unlimited shelf life until “activated” by the user via a twisting or compression procedure, or other actuation process or procedure, thus allowing the Electrolyte components to mix, establishing an electron flow from Cathode₁ to Anode₂, resulting in activation or re-activation of said Fuel Cell.

15. An Electrolyte which is not acid based, and therefore differs entirely from past known “P.E.M.” voltaic, galvanic, and electrolytic cells such as LEAD-ACID batteries establishing a new device type, which makes the following unique claim, refer to the next claim in this sequence:

16. An Electrolyte containing the first “Environmentally Non-Toxic” and “Safe to Handle/Store” Electrolyte.

17. A Fuel Cell incorporating an oxidation-reduction reaction process in which oxidation uniquely occurs at the Anode₂ immersed or suspended in the Fuel Cell's Electrolyte suspension and reduction occurs in the Electrolyte suspension, rather than at the Cathode₁, as occurs in all other previously or presently known (P.E.M.) Electrolytic/Voltaic/Galvanic processes complying with (and governed by) Faraday's Law(s).

18. A Fuel Cell employing the first Electrolyte to allow the device to be placed in “Standby” mode, once the Fuel Cell device has been activated, unlike other existing “one-time use” only Fuel Cells.

19. A Fuel Cell (or stack, or set of, or set of “Staged on Demand”) Fuel Cell(s) employing remote activation by electronic signal or device, which communicates to said Fuel Cell, a command to Activate/Re-Activate said Fuel Cell which embodies the first Electrolyte to allow the device to be placed in “Standby” mode, and subesequently be Re-Activated on demand.

20. A Fuel Cell (or stack, or set of, or set of “Staged on Demand”) Fuel Cell(s) arrangement connected in parallel or series with another Fuel Cell (or stack, or set of, or set of “Staged on Demand”) Fuel Cell(s) or used in combination with other Power Storage devices (including “multi-use” and/or “one-time” use devices) to provide redundant, auxiliary, “on-demand” or “automatic” enhanced power output, or supplemental power during periods of high demand, or EMERGENCY use, or as primary or secondary backup power during outage periods.

21. Said arrangement in claim 19 may be activated by “remote or automatic” activation by electronic signal or device, which communicates to said Fuel Cell, a command to Activate/Re-Activate said Fuel Cell which embodies the first Electrolyte to allow the device to be placed in “Standby” mode, and subsequently be Re-Activated on demand.

22. A liquid Electrolyte in which said oxidation-reduction reactions occur in aqueous solution, as compared to known or existing “P.E.M.” voltaic, galvanic, and electrolytic cells in which said oxidation-reduction reactions occur in “air,” as a result of internal chemical or externally applied thermal (heating) and/or thermal management (heat exchangers) in order to reach an operating temperature for oxidation-reduction reactions to occur; and as such, this invention establishes a new class of “Non-Proton Exchange Membrane (P.E.M.)” Oxide Fuel Cell(s), and/or “Alternate-Proton Exchange Membrane (P.E.M.)” Oxide Fuel Cell(s), and/or Aqueous Oxide Fuel Cell(s).

23. A method for activating the Fuel Cell for operation wherein the Center Cathode, Rod or Rods (in the case of FIG. 2) are inserted, via a compression or twisting (screw-in or other) motion or actuation/control into the space between the Anode₂ walls, containing the Electrolyte, thus activating the Fuel Cell for operation.

24. A method for activating the Fuel Cell for operation wherein, a similar but mirrored design in physical structure, or physical configuration of the alternate embodiment(s), the Anode₂ Honeycomb component is inserted, via a compression or twisting (screw-in or other) motion or actuation/control into the space between the Cathode, Rod or Rods, or Metallized subcells or Honeycomb cells designed to fit/conform with the Anode₂ Honeycomb containing the Electrolyte, thus activating the Fuel Cell for operation. Said “mirrored design in physical structure, or physical configuration” is in terms of construction only, and not related to the chemistry of said Fuel Cell, or its polarity of the device or its operation.
